(19) United States
(12) Patent Application Publication
(10) Pub. No.: US 2016/0192194 A1
(43) Pub. Date: Jun. 30, 2016

(54) Secure way to build internet credit system and protect private information

(71) Applicant: Gongming Yang, Shanghai (CN)

(72) Inventor: Gongming Yang, Shanghai (CN)

(21) Appl. No.: 14/585,049

(22) Filed: Dec. 29, 2014

(51) Int. Cl. H04W 12/08; H04L 29/06; H04W 12/04; H04L 29/08

(52) U.S. Cl. CPC H04W 12/08; H04L 67/02; H04L 63/06; H04L 63/083; H04W 12/04

(57) ABSTRACT

A method includes building trust system among internet users, signing up in websites without password and protecting personal data in mobile device. Global Unique Identifier (GUID) is used to identify and accumulate internet credit for users and websites. First, user applies for GUID together with asymmetric-key, then the internet credit of this GUID can be accumulated based on transactions. Also, user can sign on or log in websites via GUID without using password and user name. In addition, dual data encryption and unpredictable random number is presented to anti-surveillance of communication. The personal information in mobile device are protected by asymmetric-key pairs and destroyed automatically after being stolen and mobile device's device-ID is used to chasing the stolen devices. In summary, the present invention is a securer way to build a trust system among internet users and protect data in mobile device.

### TECHNICAL FIELD

The present invention relates to protect personal and communication information for mobile device, more specifically, relates to a method to sign in website without using password or other personal information, a method for anti-surveillance of communication, a way to build internet credit system to make safe trading.

### Background Art

It is a requirement that people is trusted by remote people when doing business in internet without asking for sensitive personal information, vice versa.

It is risky if you know nothing about the user in remote who is doing business with you, because it is possible that the remote-end is a scammer. People trend not to expose any private information to protect their information from abused, yet, this makes business difficult in internet. Even the remote-end is trusted website, it is still risky to submit private information, because hackers may stole the information from website in future. Hence, people trend to hide behind internet mainly for protecting themselves.

Techniques such as finger printer, strong password, real name authentication, iris scan etc are implemented to identify the remote people. Though it make vender or website safer, however it isn't equal for customers. All those methods need us expose private information, and we haven't a way to protect us from bad websites.

Any kind of your personal information is not secure anymore when the information in a form of digital which can be easily copied. If your finger print in digital format and the data are hacked by internet rogues, in some extreme case, your physical fingers may become a target, when the profit is big enough. To guarantee the trading or social network based on trusted persons or websites, there is a requirement to build a trust system among internet and keep people's sensitive information against any kind of leakage. It is a urgent requirement to keep our information from transfering in internet when we do business in internet.

It is another requirement that to sign up in website without personal information like user name and password. As internet becomes a part of our daily life, we have to remember a lot of username and password for accessing different website, and some password are long enough to be remembered. It is a user's dilemma: if user writes password down or use password which is easy to remember, password can be easily guessed; if user sets different strong password for different website, it is hard to be remembered for most of users. In addition to set password, there are different kinds of electronic forms in different websites waiting us to fill. To be simple and no information leakage, we need a way to sign up and login in website without username and password, and at the same time , the remote website can be authenticated before we signing up or logging in.

It is required to protect and even recover the private data in your mobile device before or after the mobile device is stolen or lost and protect our communication from surveillance. As the progress of techniques, the mobile device becomes more and more powerful that portable mobile device become popular tool for daily life like online shopping, information searching, online payment, communication with friends, even access social network. Hence, mobile device becomes the ideal device to store personal information which includes but not limits to password, bank account, personal pictures, personal identification, personal contact list and so on. Eventually, the value of the data in mobile device may worth more than the device itself. However, the mobile device is much easier to be stolen or lost. The device may be left carelessly, or drop in somewhere at home but difficult to be found, or even be stolen. In addition, it is required to generate random number which is unpredictable to against surveillance. When any data are transferred across internet, the encryption key for encrypting the data is generated by random number. Yet, the random number generated by computer is pseudo-random number which can be predicted. As long as the random number can be predicted, the key of communication can be predicted and the data of communication can be decrypted.

### SUMMARY OF INVENTION

### Technical Problem

The objects are listed as follows.

It is an object of the present invention to build trust among internet users only by the trust system on internet. This object can be divided into several small objects in details as follows. The first small object is to build a credit system for internet users based on the Global Unique Identifier (GUID). For example, internet users get a GUID from public-key center together with private-key and public-key. Then the businesses like purchasing something from website, payment and remarks related to this GUID contribute to the credits of the GUID. As the result, users can check the credit value of remote user before trade in internet. The second small object is to make internet users free from remember too many user names and passwords and fill too many electronic forms. This object is an important way to protect our personal information by not requiring sending your information across the internet. The third small object is to support a method to authenticate the website, and know the trust credit of this website before we sign up in this website or purchase anything. Internet users haven't efficient method and enough time to investigate websites, so many camouflaged or harmful website can cheat users again and again. It is time to stop bad website by our internet trust system.

The second object of the present invention is to protect personal data in mobile devices like mobile phone, pad, laptop, wearable devices and so on. This object can be divided into several small objects in details as follows. The first small object is to generate an unpredictable key for encryption. The asymmetric-key stored in your mobile device and communication need to be encrypted with random symmetric-key which should be unpredictable. The second small object is to support dual data encryption against surveillance. This techniques generates the symmetric-key by both communication ends, and encrypted with different asymmetric-key when transmitted in internet. The third small object is to chase the position of your phone with and only with the specified GUID. For example, when mobile device is stolen or missed, only the device with the dedicated GUID can chase this mobile device. The fourth small object is the mechanism to detect stolen status by the mobile device itself and destroy your personal information which can't be recovered after your mobile device is stolen. For example, after the mobile device is stolen, the mobile device can automatically detect the status of itself, and then keep the mobile device from read or write and then destroy the personal information with low level format.

### Solution to Problem

The solution of the objects is based on three important techniques: the first is to using GUID and public-key center to initialization, accumulating and querying user's internet credit, the second is to using public-key center and asymmetric-key method to authenticate users and retrieve the status of private-key and device-ID, the third is to only use GUID to sign on or log in websites to protect sensitive information transferring in internet, instead of using password, user name or personal information forms.

The object of building a credit system for internet users is realized by: using GUID to identify internet users, using the GUID to retrieve related public-key from public-key center, authenticating users by asking for encryption of some random number by the GUID's private-key, allocating GUID for every internet users and assigning initial internet credits according to the information provided by the users, ranking individual users and company users separately according to the information provided, linking bank credit to internet credit if the user allows and inputs all information required, accumulating credits according to the user's activities in internet, such as how many deals, and how many deals done without complaint, how many good or bad remarks and so on, any users with GUID can get the internet credit of other users including company users by their GUID, any users can check whether the remote end is the right owner of this GUID by asking for authentication in public-key center.

The object of making internet users free from remember too many user names and passwords and fill too many electronic forms is realized by: using GUID to log in different websites, giving the website the right to get signing up information from public-key center, the website authenticating the user's GUID, the website signing up and create profile automatically for the user with GUID and the user's information which includes email address and nickle name and so on, the user logging in using GUID and being authenticated by the public-key center.

The object of supporting a method to authenticate the websites and know the trust credit of the websites before we sign up in this website or purchase anything is realized by: checking the GUID of the website by asking for authentication in public-key center, gaining the right to access the internet credit of the website, making comments on the website after a deal is completed, adjusting the credit level by user's comments.

The object of generating an unpredictable key for encryption is realized by: generating pseudo-random number, encrypting the pseudo-random number by user's private-key. This object can be realized also by: collecting sample values of environment voice, collecting the temperature and the speed of fans, using the user's private-key to encrypt the values of natural inputs and get the unpredictable random number.

The object of making dual data encryption against surveillance is realized by: generating half of the symmetric-key by both communication ends using unpredictable random number, encrypting the half of the symmetric-key by remote-end's public-key, combining and generating the full communication symmetric-key separately by both the communication ends.

The object of chasing the position of your mobile device with and only with the dedicated GUID is realized by: calculating the hardware information of the mobile device, encrypting the hardware information using private-key and registering it as device-ID to public-key center, storing private-key status and device-ID status in public-key center, setting GUID which the mobile device will response the chasing message, returning the position information if available to the chasing device with the dedicated GUID, taking further actions like opening microphone, enacting camera or sounding alarms according to the instruction of the chasing device.

The object of detecting stolen status by mobile device itself and destroying personal information using low-level format is realized by: encrypting the private-key by inputting password, encrypting personal information by public-key such as password, contact book information and so on, checking the status of the private-key and device-ID every time the private-key is used for billing or important information retrieving like decrypting personal information like private-key or contact book and so on, setting status of this device as stolen or missing, setting the further actions for the mobile device with the device-ID, the mobile device refusing to do any business before the mobile device can get the proper status of private-key and device-ID from public-key center, destroying personal information using low-level format after get the indicator from the public-key center or the chasing devices with the dedicated GUID.

### Advantageous Effects of Invention

The GUID is unique globally and protected by private-key. No any one except the owner of GUID can use GUID in internet, because there are no any personal information need to be transmitted in internet. Even attackers steal your private-key from your mobile devices, they can't decrypt it because private-key is protected by unsaved password. Even attacker can decrypt your private-key, you still can protect your personal information and your key by setting the status of private-key and device-ID as stolen, then your can obsolete the leaked key.

The internet credit of users build a trust system based on GUID, and keep our personal information from abused. When we do business in internet, the internet credits of the GUID tells whether the remote-end can be trusted or not, so, you don't need to leak any your personal information to remote-end and trusted by remote-end. The online payment using GUID is a safer and more convenient ways than almost all current online payment method. Even your private-key is leaked, you can easily and without delay to obsolete the private-key to protect your money.

Being signed up and Logging in website with GUID and free from user name and password and any other kind of personal information forms will make users use internet in a better way. Also, users have a very quick and convenient way to check the credit and keep away from the phishing or malicious website. We and make our accounts safer than before and without setting and remember any password, and we don't need to worry about when and where and how some websites leak their clients payment and account information, because even we had purchased something in the websites the websites still haven't any payment method can be stolen or hacked. Also, at the same time, the websites with our technique will gain trust from customers easier than before.

User changes the status of private-key and device-ID stored in public-key center when user realizes the mobile device is stolen or missing, whenever the mobile device get the abnormal status, it will destroy personal information according to the settings for this device. The device will refuse to access any private information stored in the device before the status is clear. Also, the missed mobile device allow to be chased by any device with specific GUID. Even the Operation System of the missed mobile device is changed, we can identify this device by calculating the device-ID and refuses this device being used by other user with different GUID.

The dual symmetric-key and the unpredictable ways to generate random number help to protect communication easier to anti-surveillance.

### BRIEF DESCRIPTION OF DRAWINGS

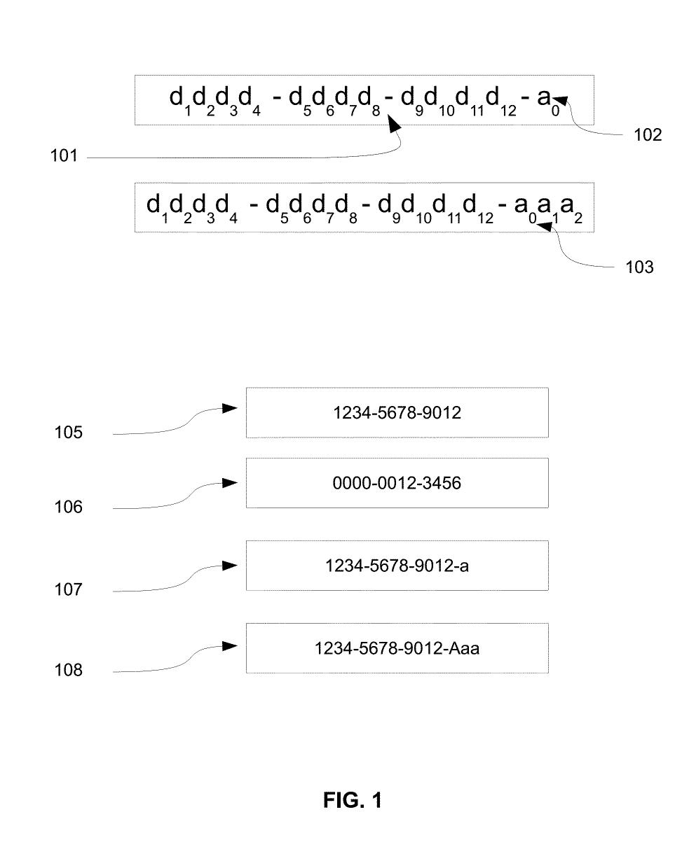

{FIG. 1} illustrates the procedure to define Global-Unique-ID(GUID).

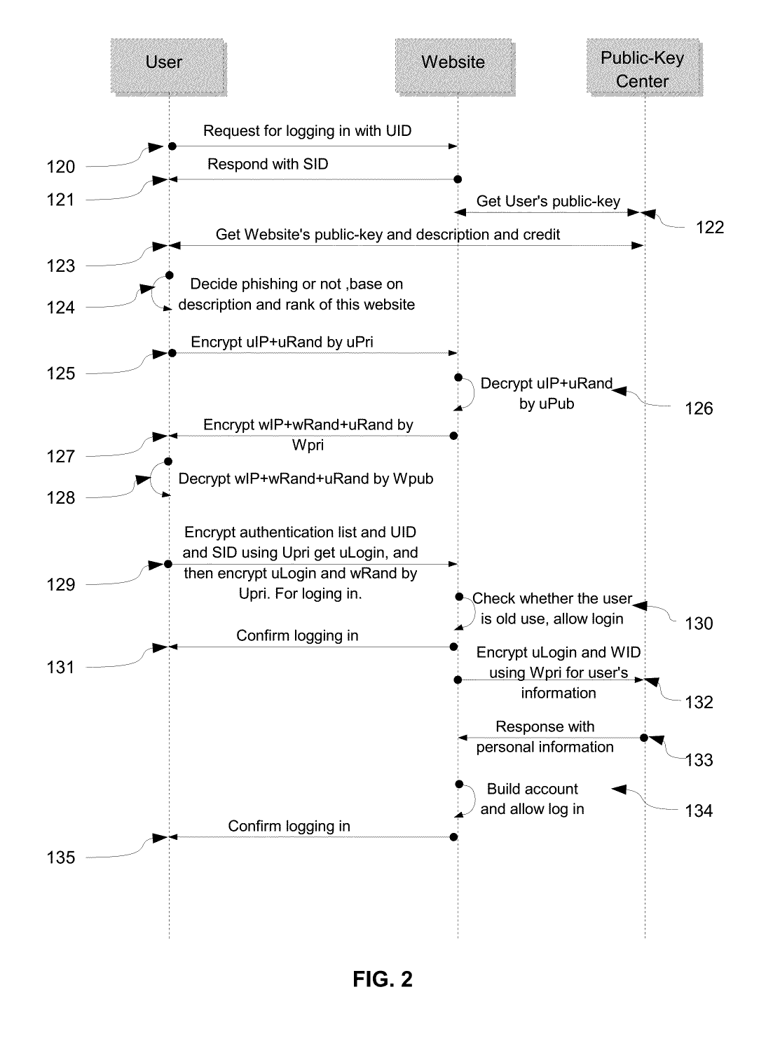

{FIG. 2} illustrates the way to sign up or log in website without using user name and password.

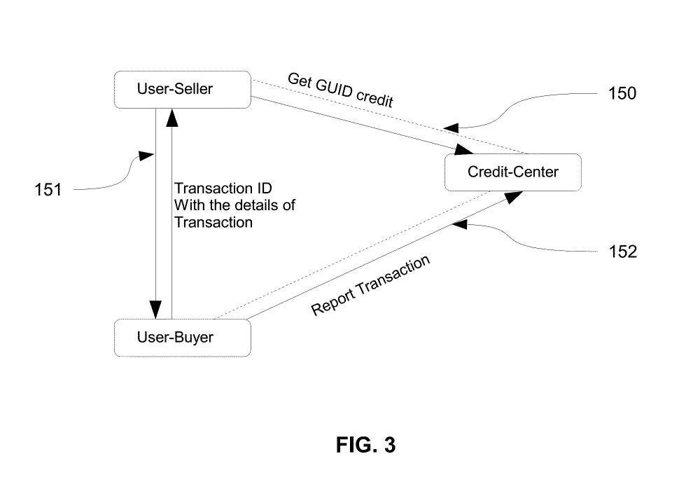

{FIG. 3} illustrates the way to build up internet credit system.

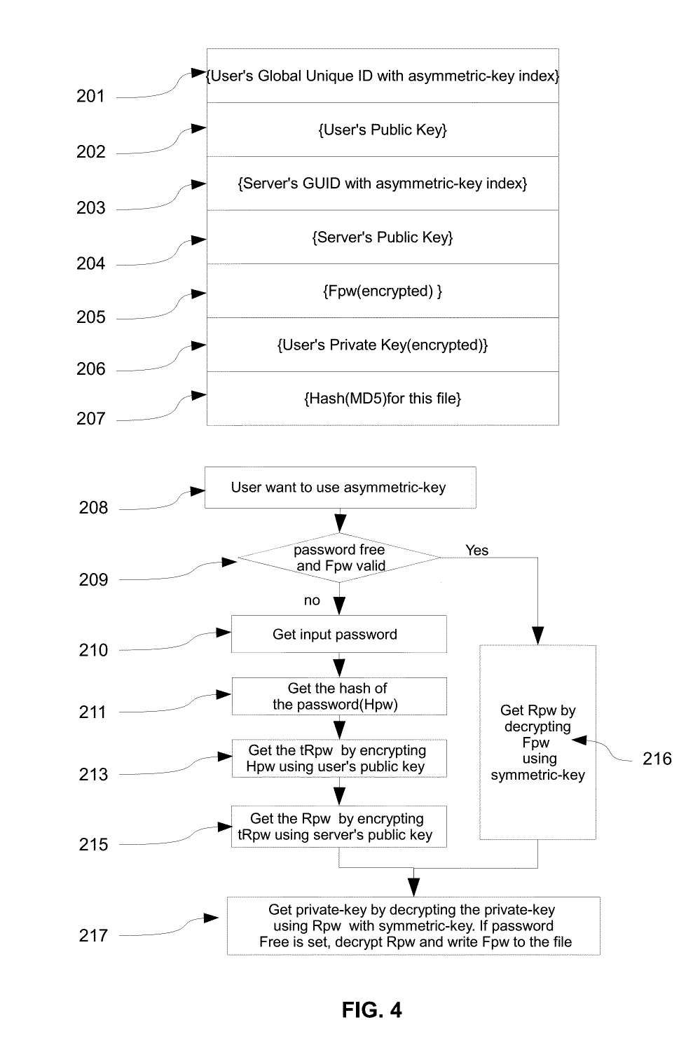

{FIG. 4} illustrates the way to store the asymmetric-key in mobile device.

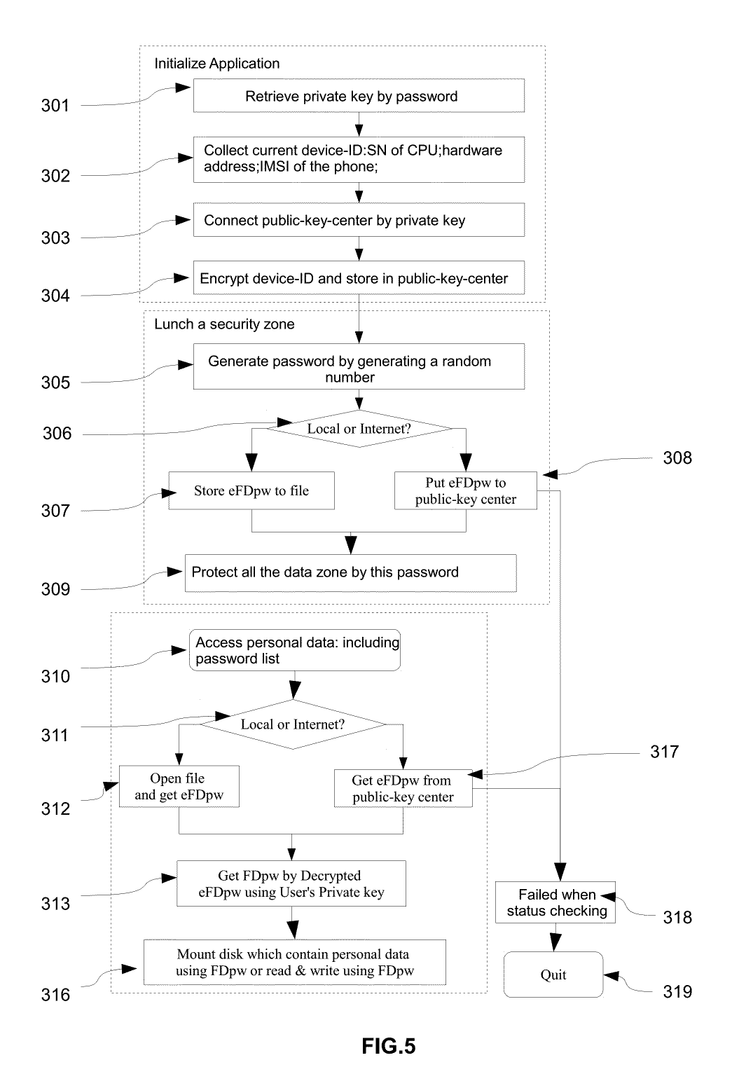

{FIG. 5} illustrates the way to keep personal information and password in a secure way.

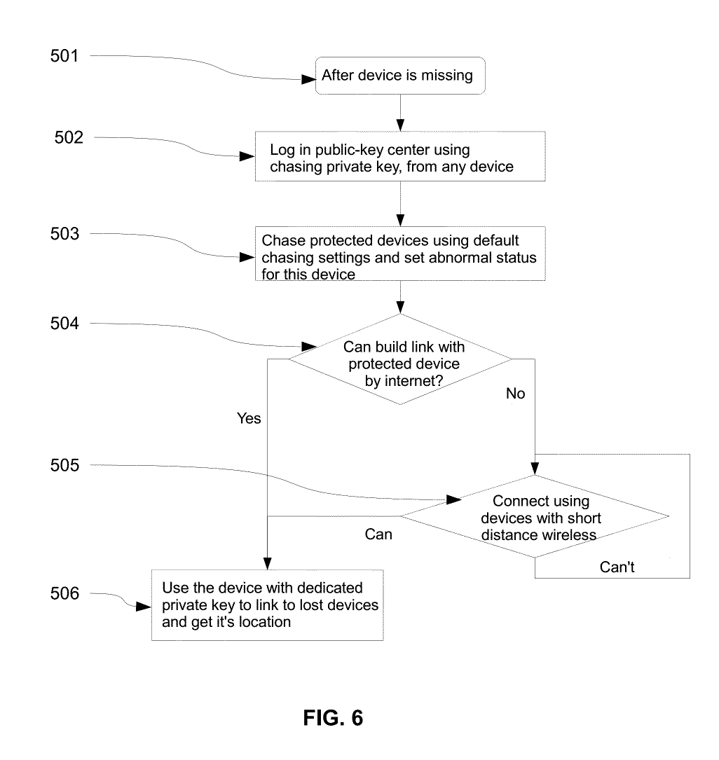

{FIG. 6} illustrates how the owner takes actions to find the mobile device as soon as the owner is aware that the mobile device is missing or stolen.

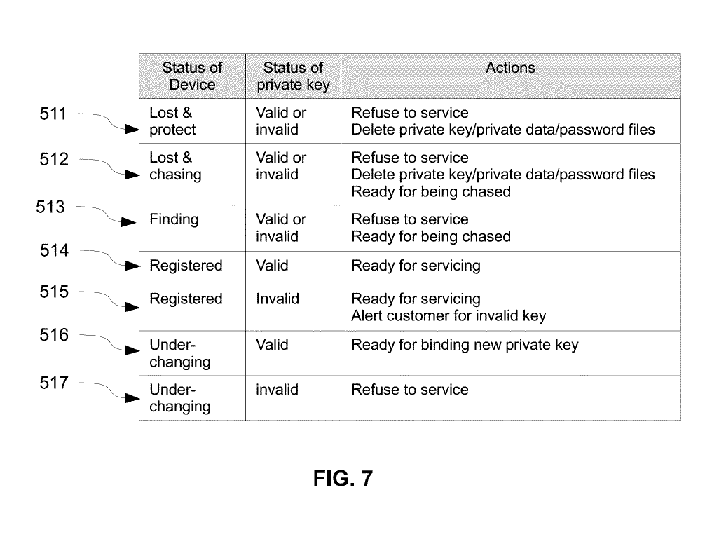

{FIG. 7} illustrates the further actions for different status of the asymmetric-key and the device-ID.

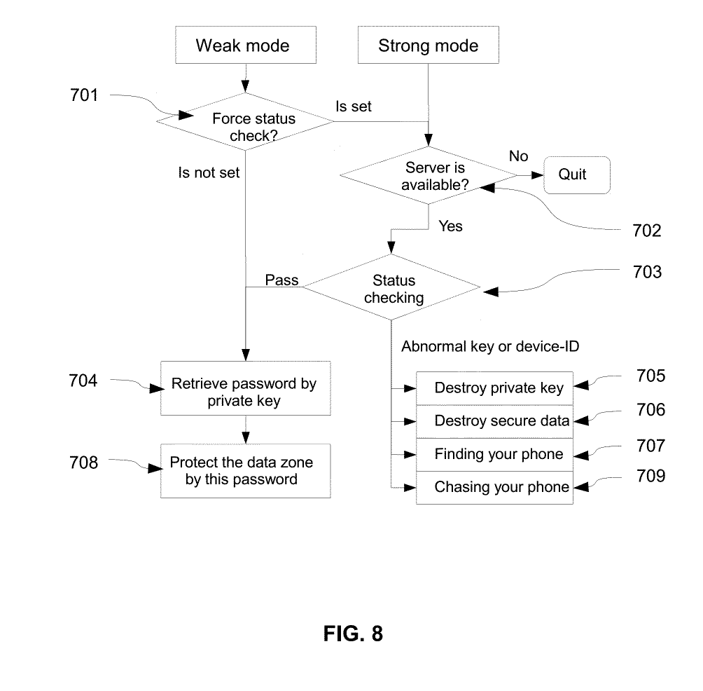

{FIG. 8} illustrates how mobile device detects it's status and take further actions.

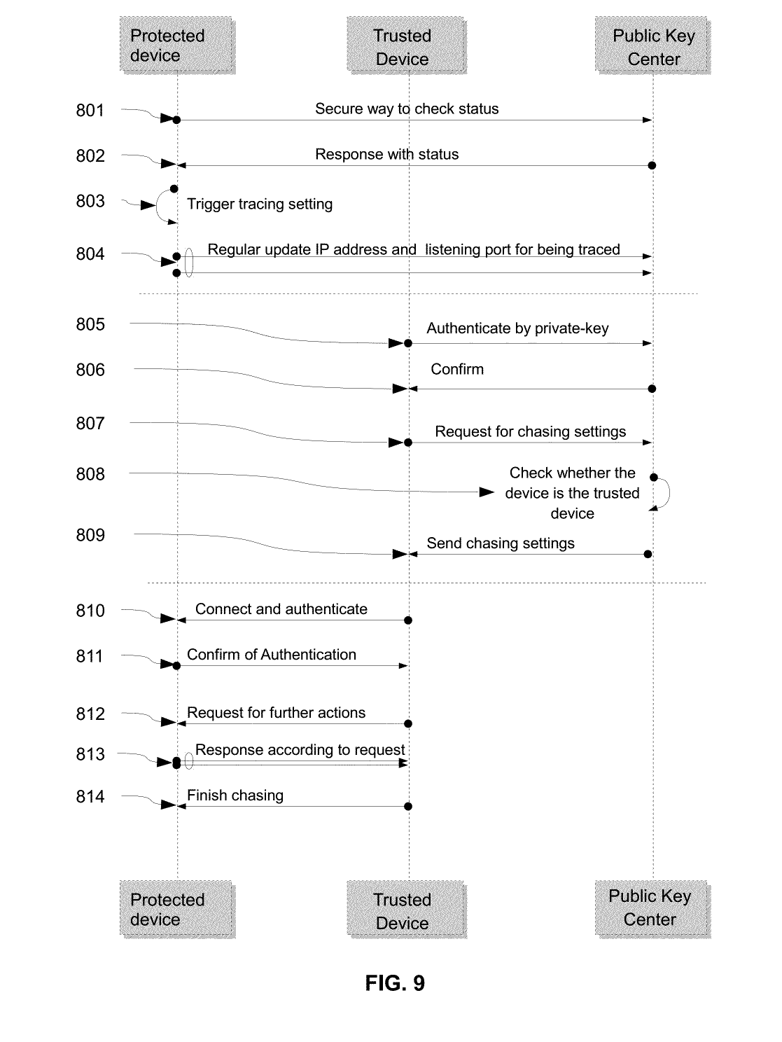

{FIG. 9} illustrates the details of how mobile device performs the further action of ‘finding your phone’.

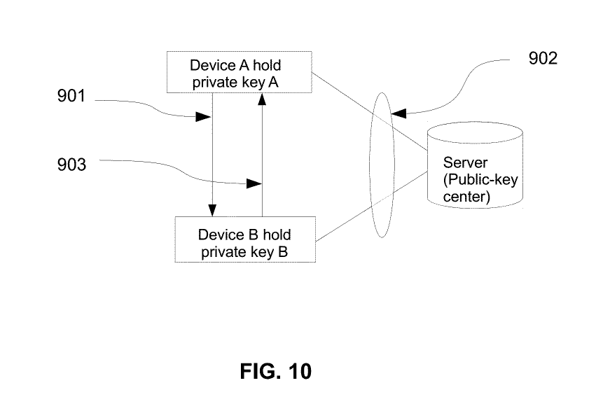

{FIG. 10} illustrates the details of how dual asymmetric-key to generating combined key for symmetric-key data communication.

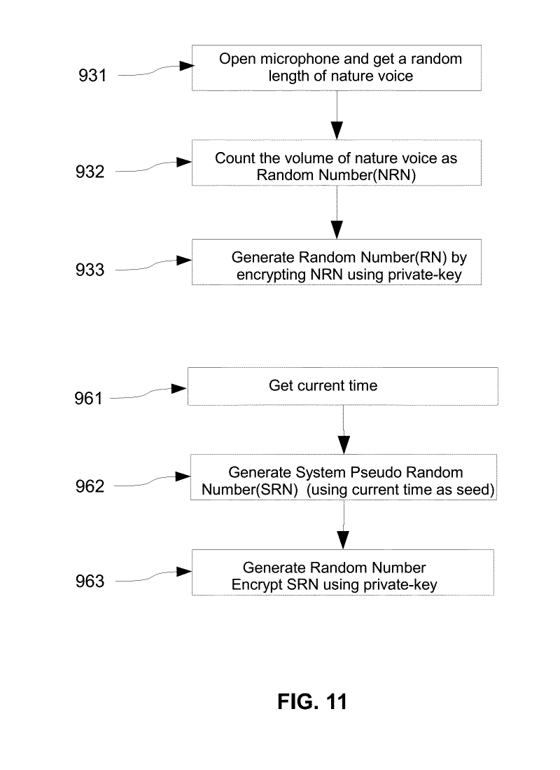

{FIG. 11} illustrates the details of generating secure random number.

### DESCRIPTION

### Description of Embodiments

### EXAMPLES

There are three embodiments. Example 1 embodies the way to sign up and log in website without providing user name and password. Example 2 embodies the way to build up internet system based on GUID. Example 3 shows the embodiment of protecting personal data in mobile device. Example 4 shows the method of protecting communication by dual asymmetric-key. Example 5 shows the embodiment of generating securer random number.

### Example 1

This embodiment will be described based on accompanying drawings. In this example, the details of how to sign up and log in website without providing user name and password are described.

{FIG. 1} illustrates the procedure to define Global-Unique-ID(GUID). The GUID is constructed by 12 digits like what the 101 shows. The leftest is the most important digital. If the GUID is constructed by digits less than 12, the left most digital will be filled with zero to make the GUID with 12 digits. The 102 is the asymmetric-key index for individual users which contain only one character from ‘a’ to ‘z’. The 103 is the asymmetric-key index for commercial users which may need more asymmetric-keys for supporting different customer's. The first character is from ‘A’ to ‘Z’, and total 3 characters. The 105 is typical GUID for 512 bit asymmetric-key which means the user is low credit user. The 106 is the GUID with less than 12 digits. The 107 is an example of GUID for individuals and the 108 is for commercial users.

{FIG. 2} illustrates the way to sign up or log in website without user name and password.

The step 120, user send log-in request to website with the user's GUIDI (GUID with asymmetric-key index) and ask for the website's GUIDI. Then, in the step 121, the website responses with it's GUIDI. In 121, the website responses user with it's GUIDI. In 122, the website checks the validation and get the public-key of the user from public-key center, in the step, the website log in the public-key center. At the same time, in 123, the user gets the description and credit of the website and get the website's public-key with the GUIDI of the website. In the step 124, user can decide whether this is the right website the user wants to visit, based on the description of the public-key.

In step 125, user generates a random number uRand and encrypts uRand together with user's IP address by user's private-key (uPri). This message can be decrypted by anyone with user's public-key, but it is difficult to be modified. In step 126, the website decrypts the message, and get uIP and uRand, then compares the uIP with the source IP of this TCP package. If the two IP isn't the same, then drops this message because it may be attacked.

In step 127, website generates a random number (wRand) and encrypts wRand together with uRand and website's IP address by website's private-key, and then send this message to user. In step 128, user decrypts the message using website's public-key and gets wIP and wRand and uRand, and then compares the wIP with the source IP and the uRands. If all are the same, then the user can make sure that it is the right website, otherwise, the website or the communication data is modified. In step 129, user sends a message to allow the website to get user's logging in information. The uLogin message is generated by encrypting user's GUIDI (UID) and website's GUIDI (WID) and authentication code by user's private-key. The authentication code which can be recognized by public-key center is a code to share the parts of user's information with the WID. Also, the user forms authentication message by encrypting uLogin and wRand using user's private-key. In step 130, the website decrypts user's authentication message and gets wRand and uLoin. If the wRand isn't the same as the original wRand, then the website will refuse the user. Then the website checks it's database for this user. In step 131, if the database has the record for this user, the website sends conformation message and let the user logs in. If the user is a new user, In step 132, the website generating an information request for public-key center by encrypting the uLoin and website's GUIDI using website's private-key. In step 133, the public-key center will decrypt the message and get WID and uLogin and authentication code, and decrypt the uLogin by user's public-key and get UID and SID. Then WID and SID are compared and generate a message by decrypting a message which contains all user's information indicated by the authentication code. In step 134, the website will decide to sign up the user or not by the user's information decrypted by the message. If the website decide to allow this user, then build a new account for the user and allow user to log in by send a conformation to the user. After step 134, the user logs in website successfully without provide any user name and password or transfer any keys or password across the internet. And the user can create or complete the user's information in the log-in page in the website.

### Example 2

This embodiment will be described based on accompanying drawings. In this example, the details of building up internet system based on GUID are described.

{FIG. 3} illustrates the way to utilize and accumulate internet credits. In the internet credit systems, any users including company users are part of the credit system. The credit center will get transaction report from authorized users like the company users or the user with good credit. The credit-center build up the credit with basic information like transaction amount, transaction type, with or without good or bad remarks. In this example, the User-Seller and User-Buyer will do business based on the name of GUID. In step 250, both User-Seller and User-Buyer get credits of GUID from public-key center before make business decision. Then in step 251, the User-Seller who is the company user report the brief transactions with unique transaction ID to Credit-center after they complete their transaction. And both User-Seller and User-Buyer have the right to report or not to report their attitude about this transactions to Credit-Center which will affect the credit of each other. By step 250 to 252, users with GUID build their credits and using the credits to gain trust among each other.

### Example 3

This embodiment will be described based on accompanying drawings. In this example, the details of protecting personal data in mobile device are described.

{FIG. 4} illustrates the way to store the asymmetric-key in mobile device. The asymmetric-key is very important property and is protected by password. To keep the password confidential, attacker should be very difficult to know password by reverse calculation even when the file of asymmetric-key is leaked. From 201 to 207, show how the asymmetric-key file is constructed. The 201 stores the user's GUIDI. The 202 is the public-key of this GUIDI which doesn't need to be encrypted, the public-key is constructed by length, n and e whose format can be defined according to real environment. The 203 is the public-key center's GUIDI which used to log in public-key center. The 204 is the public-key of public-key center's GUIDI. The 205 is optional for password free mode which is used when the owner of this asymmetric-key can access asymmetric-key without input password every time. The Fpw (encrypted Rpw which is the key for decrypt asymmetric-key) is the key used by symmetric-key for decrypting user's private-key. The 206 is the encrypted private-key by Fpw. The 207 is the hash (MD5) value of the asymmetric-key file to check whether the file is attacked or not.

From 208 to 217 show how to decrypt user's private-key. If the owner of this GUIDI set password free then Fpw is used to record the key for decrypting private-key and then the owner can access the asymmetric-key without any input, otherwise, the password is asked. In 209, the valid of Fpw is checked by checking the decrypted private-key is valid or not. if password free is set and Fpw is valid, then go to 216 to retrieve Fpw directly, otherwise go to 210 asking for password. In 210, the program asks user to input password. Then the 211 get Hpw by hash the password using MD5 or SHA. In 213, get tRpw by encrypting Hpw using user's public-key, In 215, get Rpw by encrypting tRpw using public-key center's public-key. If attacker wants to get password by reversing calculation, the attacker need know the private-key of the public-key center and the private-key of the user and then crack the MD5. The attacker can't get all this information, so the password set by the user is safe enough.

In 216, user can access private-key without password, in this case, the program reads Fpw from asymmetric-key file. Then decrypts the Fpw by a key set in program and get Rpw. The key is calculated by the device-ID and a fixed number set in the program. The Fpw can calculated by Rpw at the same way.

In 217, the private-key is calculated by Rpw with AES symmetric method, then the program can use private-key to encrypt or decrypt data or password for customer.

If the password free is set, then, the Fpw will be generated by Rpw and rewrite to asymmetric-key file.

{FIG. 5} illustrates the way to keep personal information and password in a secure way. From 301 to 304 illustrates the method to initialize application. In 301, the application retrieves the asymmetric-key by inputting password. In 302, calculates the device-ID, which includes the static device-ID and dynamic device-ID, the static device-ID is the identification of this physical mobile device, and the dynamic device-ID is the identification of accessing services whose changing will trigger force-status-checking before using private-key. In 303, if it is the first time for installation, the mobile device have to connect to public-key center to verify the validation of the private-key and the device-ID using current private-key. In 304, after the private-key is authorized, the device-ID is sent to public-key center, and the static device-ID is searched in public-key center, if this static device-ID exist already and the status of this device-ID isn't unregistered, then the public-key center will refuse this device-ID, the mobile device will wait for further actions according to the setting of the static device-ID in the public-key center.

From 305 to 309, the mobile device lunchs a new security zone to protect personal data. There are two ways to protect personal data, one is directly using user's public-key to encrypt for small size personal data like password list, the another is to protect using symmetric-key (FDpw). The mobile device already have public-key by accessing asymmetric-key file, so we need a method to generate and store symmetric-key. In 305, a random number is generated using system random functions or using nature input, and the random number is encrypted by user's private-key to get a password which is difficult to be guessed. In 306, the method to store Fdpw is decided by settings. The weak mode is storing FDpw in local file and the strong mode is storing Fdpw in public-key center. In 307, the FDpw is encrypted by user's public-key and get eFDpw, and store eFDpw into file. In 308, the mobile device connects public-key center and backups the eFDpw in server, and in this step the validation of the private-key and the device-ID is checked. In 309, a disk or a fold or any kind of data zone which is protected by the password Fdpw is created.

From 310 to 317, it is the way to access personal data. In 311, the application know where to get FDpw by the configuration file. In 312, open symmetric-key file and get eFDpw. In 317, the application connects public-key center and get eFDpw, in this step, the status of private-key and device-ID is checked. If the status is abnormal, the application will take further actions. Then in 313, the application get FDpw by decrypting eFDpw. Even eFDpw is leaked, it is still difficult to be decrypted by attacker. In 316, the FDpw can be used to decrypt or encrypt, and mount related disk. The 318 and 319 is the abnormal handling process, when the status of private-key and device-ID is abnormal. The application will refuse to use private-key or FDpw before take further actions.

{FIG. 6} illustrates how the owner takes actions to find the mobile device as soon as the owner is aware that the mobile device is missing or stolen. In 502, the owner logs in public-key center using any asymmetric-key with the same GUID. In 503, the owner set the status of the mobile device according to the status of the mobile devices. Then set the status accordingly. This step is very important for the owner to protect the private-key. After the changing of status, any online-payment or accessing to this asymmetric-key will be refused. The details of further actions are listed in FIG. 7. In 504, the owner will try to link with the lost mobile device using default TCP/UDP port. In 506, if the mobile device is still active in internet, the owner can connect to the lost mobile device and get it's location periodically and command the mobile device to take further operations like opening microphone to record and sending voice to the owner, or sending location periodically or deleting all the personal information by low-level formatting and so on. In 505, if the mobile device is broken from the internet, then the owner still can connect this device by short wireless links such as blue tooth or WIFI using default TCP/UDP port.

{FIG. 7} shows the further actions for different status of the asymmetric-key and the device-ID. As long as the status of Device-ID is ‘lost’ status, in 511 and 512, the mobile device will refuse to use asymmetric-key, and delete the personal information, and be ready to be chased whenever the internet or short wireless is available. In 513, if the status of Device-ID is only ‘Finding’, the data will not be deleted but the mobile device will refuse to use asymmetric-key, and the mobile device is ready to be chased. In 514 and 515, the ‘register’ status of device-ID means this device-ID belong to a dedicated user. If the status of asymmetric-key is invalid, the action is to prop alarm because the device may be in good status. In 516, the ‘Under-changing’ status of device-ID means this mobile device is never been assigned to a dedicated user, so the device is free to accept or bind new asymmetric-key. In 517, the asymmetric-key exists and is invalid, that status indicates that the device-ID may belong to a dedicated user but be transferred to a new user, yet, the old user's private-key is still in mobile phone, so in this case, the mobile device will refuse to use the asymmetric-key and waits for being bound to a new asymmetric-key.

{FIG. 8} illustrates how mobile device detects it's status and take further actions. As we know, the mobile device is very hard to know itself is stolen or missing, so the mobile device need a method to get the status. We design two modes. The strong mode will ask for the status of the device from public-key center every time the device uses asymmetric-key, so the asymmetric-key is protected strongly, yet it need to access internet all the time so isn't fit for some off-line application. The weak mode will check the status of asymmetric-key or device-ID only when force status check is set. The force status check is set when the application is just start or the mobile device is been blocked or the mobile device is in idle status for a dedicated time. In 701, every time the asymmetric-key is used, the force status will be checked, if it is set, the mobile device will check the status anyway. In 704, the asymmetric-key key is free to be used, here, it is used for decrypting to get password FDpw. In 708, the data zone is mounted or written by FDpw. In 702, the mobile device will connect the public-key center by asymmetric-key and check the status of the device-ID and this asymmetric-key. In 703, the status checking is performed. From 705 to 709, the different combination of further action for abnormal key or device-ID is performed by the mobile device. 705 will destroy the asymmetric-key only, 706 will destroy secure data, 707 will finding the phone, 709 will chasing the phone. The combinations of further actions are showed in FIG. 7.

{FIG. 9} illustrates the details of how mobile device performs the further action of ‘finding your phone’. The protected device is the device that is missing or stolen, the trusted device is the device with dedicated GUIDI which is trusted by the protected device, the public-key center is the service provider. From 801 to 802, the mobile device check status of asymmetric-key and device-ID from public-key center. In 803, the mobile device is triggered to be found by the owner. So, in 804, the mobile device will regularly update it's IP address and the listening port for accepting chasing. From 805 to 809, the owner of the protected mobile device using trusted device to log in public-key center and get chasing settings. In 805 and 806, the trusted device connect to public-key using private-key. In 807 and 808, the trusted device requests and gets chasing settings including the TCP/UDP port and IP address. After the trusted device get details of how to reach the protected device, In 810 and 811, it connects to protected device using it's private-key. To finish authentication, device B encrypt a random number from device A using device B's private-key, and the device A decrypts the message from B by device B's public-key, if device A can get the same random number, then device A trusts device B is authorized by dedicated GUIDI. In 812, the protected device get the list of further actions. In 813, the protected device deletes personal information or sending location information according to the list of further actions till receives the message from trusted device to indicate ‘finish chasing’.

### Example 4

This embodiment will be described based on accompanying drawings. In this example, the details of protecting communication by dual asymmetric-key are described.

{FIG. 10} illustrates the details of how to use dual asymmetric-key to generating combined key for symmetric-key data communication. In 902, the device A and device B connect to public-key center using their asymmetric-key, and get the communication settings of each other which include but not limited to IP address and TCP/UDP ports and GUIDI, and the encrypt protocols and the method to combine two part of keys. The public-key center, never store or interfere the key exchanging and data communication of the devices, so the communication will not be attacked from public-key center. In 901, device A generates a random number (RNA) and constructs a key message (KMA) which encrypts RNA by device B's public-key. Device B get RNA by decrypting KMA using it's private-key. The RNA can and only can be decrypted by device B by this step. In 903, device B generates a random number (RNB) and constructs a key message (KMB) which encrypts RNB by device A's public-key. Device A get RNB by decrypting KMB using it's private-key. After step 901 and 903, both device A and device B get RNA and RNB, and then combines RNA and RNB using the same method which is known by both devices. The method can be free defined because it will not affect the secure level. One of the method can use RNA to encrypt RNB and using the encrypted number as the key. After 903, the two device's communications such as voice, video, text and so on are all encrypted by the dual key. We can freely choose AES, DES or other algorithm to generate the symmetric-key, as long as it is fixed defined by both devices in step of 902.

### Example 5

This embodiment will be described based on accompanying drawings. In this example, the details of generating securer random number are described.

{FIG. 11} illustrates the details of generating secure random number. From 931 to 933, illustrate how to using nature input to generating random number. In 931, the device opens microphone and collect a random length of nature voice, the input can be but not limited to video, speed of fan, temperature. In 932, counting the volume of sampled voice and uses the result as the random number (NRN). The nature voice may not be completely silent, so, after a random length of time to collect nature voice, this random number will be more difficult to be guessed. In 933, we all know that this random number can be guessed by knowing the environment of the device, so, we using the device's private-key to encrypt this NRN and use the result as the final RN. As long as the NRN is random, the RN will be random, because from NRN to RN is a fixed procedure.

From 961 to 933, illustrate how to generate random number without the assistance of getting nature input. As we all know that the CPU or some software have many different ways to generate random password, but there are all pseudo random number. Yet, a key that can't be guessed by attacker doesn't have to be perfect random number. In 961, we get current time as seed for generating pseudo random number. In 962, we generate a pseudo random number (SRN) by any means including but not limited to Rand( ) functions supported by system. Then In 963, the final Random Number (RN) is generated by decrypting SRN using user's private-key. Though, in theory, RN is a pseudo random number, RN is very difficult to be guessed. Attacker need the private-key to get the final RN.

1. A secure method of signing up and logging in website without user name and password, the method comprising: uniquely identifying users by global-unique-ID (GUID), combining GUID with email address, authenticating users by private-key without user name and password, updating contact information by GUID, sharing user's basic information with website according to user's permission, automatically recording and encrypting user name and password and constructing message to log in dedicated website, building internet credit system for internet users based on the business or trading fulfilled by user's GUID to allow internet users trust each other without know personal information.

2. A secure method of protecting personal information which are stored in mobile devices, the method comprising: protecting asymmetric-key by password, protecting personal data and password list by encrypting with public key with weak mode and strong mode, uniquely identifying mobile device by device-ID, automatically performing actions to personal data according to the status of both asymmetric-key and device-ID after mobile device is missing or stolen, deleting personal data by low-level formatting, finding or chasing mobile devices after mobile device is missing or stolen.

3. A method of securing communication against surveillance, the method comprising: securing data by dual asymmetric-key, creating random number by natural inputs like environment voice or temperature or the speed of fan, creating random number by user's personal private-key, encrypting data of communicating pair to pair without interference by server.

4. The method of claim 1, wherein uniquely identifying users by global-unique-ID (GUID), the method comprising: designing GUID by numbers and one GUID is uniquely mapped to one and only one user, attaching asymmetric-key index to indicate different asymmetric-key which belongs to the same user, indicating commercial users by starting character of asymmetric-key index, designing shorter and easy-to-remember numbers for high rank customers, any email address is uniquely mapped to one GUID, GUID with the asymmetric-key index uniquely identifies one unique asymmetric-key, logging in using either email address or GUID with assistance of dedicated asymmetric-key.

5. The method of claim 1, wherein building internet credit system for internet users based on the business or trading fulfilled by user's GUID to allow internet users trust each other without know personal information, the method comprising: accumulating user's internet credit by the business fulfilled in internet, allowing users to setup different GUIDs which can contribute to their internet credits, allowing companies to report their customer's internet credit, bind score of credit with the real transactions with user's GUID, allowing users to query for the internet credits of others.

6. The method of claim 1, wherein authenticating users by private-key without user name and password, the method comprising: user logging in with either GUID or email, website identifying user by asking for decrypting both random number and user's IP address and vice versa, ranking user's credit independently by user's information and trading history, user getting remote user's description and credit from public-key center to against phishing, user encrypting the authentication information by user's private key, user authorizing website by sending encrypted message by private-key which contains user's GUID and website's GUID and authorizing code to website, website getting dedicated personal information from public-key center with the encrypted authorized message, public-key center identifying website by website's private key.

7. The method of claim 1, wherein updating contact information by GUID, the method comprising: users maintaining a list of friends by the identification of GUID, users updating their contact information in public-key center, user's authorized friends getting the contact information of user by public-key center.

8. The method of claim 1, wherein sharing user's basic information with website according to user's permission, the method comprising: public-key center authenticating website and user, public-key center retrieving user's original authorization by decrypting original message using user's public-key.

9. The method of claim 6, wherein website identifying user by asking for decrypting both random number and user's IP address and vice versa, the method comprising: user encrypting user's IP and a random number generated by user (uRand) using user's private-key, website decrypting the message by user's public-key and requiring the source IP of the message is the same as the IP decrypted from the message, website encrypting website's IP and a random number generated by website (wRand) and uRand to user by website's private-key, user requiring the uRand is the same as what is generated and the source IP of the message is the same as the IP decrypted from the message, user generated an authorization message (uLogin) using user's GUID with the asymmetric-key index(GUIDI) and website's GUIDI and authorization code using user's private key, user generated a sign-up message (uSUMESS) by encrypting uLogin and wRand using user's private-key, website requiring the wRand retrieved from the uSUMESS is the same as what is generated, website checking user's GUID to decide whether the user is a returned user or not, website getting user's personal information by attaching uLogin message to public-key center and signing up the user, user detecting phishing by comparing the website's description and rank with what the user tries to visit.

10. The method of claim 1, wherein automatically recording and encrypting user name and password and constructing message to log in dedicated website, the method comprising: signing up and logging without user name and password, storing the list of user name and password for websites by encrypting the list using public-key, automatically logging in website by generating message with user name and password for specific website, manually copying user name and password to log in website when the website don't support logging by constructed log in message.

11. The method of claim 2, wherein uniquely identifying mobile device by device-ID, the method comprising: generating the static device-ID by the hardware serial number and MAC (Media Access Control) address and mobile device's vendor information, generating the dynamic device-ID by IMSI (International mobile subscriber identity) number, identifying the mobile device by the device-ID, generating device-ID by both static device-ID and dynamic device-ID, binding one unique device-ID to a unique mobile device and belonging to one unique GUID, finding or chasing or taking action for the mobile device by and only by the asymmetric-key which belong to it's bound GUID.

12. The method of claim 2, wherein protecting asymmetric-key by password, the method comprising: generating key's symmetric-key (SKEY) by encrypting password by user's public-key and public-key center's public-key, encrypting or decrypting private-key by SKEY, supporting back-up SKEY by encrypting SKEY with the public-key center's public-key, supporting weak mode by storing SKEY in mobile device to allow accessing without password, supporting strong mode by storing SKEY in public-key center.

13. The method of claim 2, wherein protecting personal data and password list by encrypting with public key with weak mode and strong mode, the method comprising: protecting personal data by encrypting with data symmetric-key (DSKEY), protecting personal data by mounting a disk or fold using symmetric-key (DSKEY), protecting password files and DSKEY by encrypting them with user's public-key, strong mode protecting DSKEY by storing DSKEY in public-key center that every time the mobile device need to be authorized by public-key center before accessing personal data or password list.

14. The method of claim 2, wherein automatically performing actions to personal data according to the status of both asymmetric-key and device-ID after mobile device is missing or stolen, the method comprising: user logging in public-key center and changing the status of private-key and device-ID after mobile device is missing or stolen, mobile device refusing to access personal data if the status of private-key and device-ID isn't normal, mobile device taking further actions by the current status of private-key and device-ID automatically, mobile device keeping trying to get status before access personal data when it is in forcing-status-checking mode, the mobile device checking status of private-key and device-ID every time when performing online-payment or log in website or access personal data and password, the mobile device changing into forcing-status-checking mode when the status of mobile device meets the set conditions like the changing of IMSI etc or trying too much passwords for private-key.

15. The method of claim 2, wherein finding or chasing mobile devices after mobile device is missing or stolen, the method comprising: target mobile device (TARM) storing chasing user's GUID (CGUID) and CGUID's specified asymmetric-key index and the public-key, TARM reporting it's IP address period to public-key center, TARM listening to a specific port to allow chasing by CGUID when the status of device-ID indicate TARM is under chasing or finding, CGUID connecting TARM, TARM authenticating CGUID by public-key and random number, the owner of the TARM send further actions to TARM by CGUID such as but not limited to make voice or open camera or destroy itself, TARM reporting position which is encrypted by public-key of CGUID to CGUID periodly for security.

16. The method of claim 15, wherein CGUID connecting TARM, the method comprising: CGUID connecting TARM by internet, TARM opening short distance wireless (SDW), CGUID connecting TARM by short distance wireless (SDW) when TARM can't access internet such as in airplane mode.

17. The method of claim 3, where in securing data by dual asymmetric-key, the method comprising: both the users generating a half part of the asymmetric-key for encrypting communication data, every users generating and encrypting a random number using the remote user's public-key, every users decrypting random number by it's private key and combining the two random number into one asymmetric-key by a fixed method known by both users.

18. The method of claim 3, wherein creating random number by user's personal private-key, the method comprising: creating basic random number (BRN) by any system's random function, creating random number by encrypting BRN using user's private-key.
